(19) United States
(12) Patent Application Publication
(10) Pub. No.: US 2024/0004686 A1
(43) Pub. Date: Jan. 4, 2024

(54) CUSTOM RESOURCE DEFINITION BASED CONFIGURATION MANAGEMENT

(71) Applicant: VMWARE, INC., Palo Alto, CA (US)

(72) Inventors: John E. BREZAK, Camano Island, WA (US); Praveen TIRUMANYAM, Bangalore (IN); Narasimha Gopal GORTHI, Bangalore (IN); Kalyan DEVARAKONDA, Bangalore (IN)

(21) Appl. No.: 17/940,084

(22) Filed: Sep. 8, 2022

(30) Foreign Application Priority Data
Jul. 1, 2022 (IN) 202241038018

(51) Int. Cl. G06F 9/455; G06F 9/445

(52) U.S. Cl. CPC G06F 9/45558; G06F 9/44505; G06F 2009/4557

(57) ABSTRACT

A method of managing configurations of a software-defined data center (SDDC) includes: retrieving a current configuration of a first management appliance of the SDDC and a current configuration of a second management appliance of the SDDC; calling a first custom resource object of a container orchestration platform to acquire a desired configuration of the first management appliance and calling a second custom resource object of the container orchestration platform to acquire a desired configuration of the second management appliance; determining a difference between the current and desired configurations of the first management appliance and instructing the first management appliance to apply the desired configuration of the first management appliance; and determining a difference between the current and desired configurations of the second management appliance and instructing the second management appliance to apply the desired configuration of the second management appliance.

### RELATED APPLICATIONS

Benefit is claimed under 35 U.S.C. 119(a)-(d) to Foreign Application Serial No. 202241038018 filed in India entitled “CUSTOM RESOURCE DEFINITION BASED CONFIGURATION MANAGEMENT”, on Jul. 1, 2022, by VMware, Inc., which is herein incorporated in its entirety by reference for all purposes.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

It has become common for multiple SDDCs to be deployed across multiple clusters of hosts. Each cluster is a group of hosts that are managed together by the management software to provide cluster-level functions, such as load balancing across the cluster through VM migration between the hosts, distributed power management, dynamic VM placement according to affinity and anti-affinity rules, and high availability (HA). The management software also manages a shared storage device to provision storage resources for the cluster from the shared storage device, and a software-defined network through which the VMs communicate with each other. For some customers, their SDDCs are deployed across different geographical regions, and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not have to carry out management operations on the SDDC, such as configuration, upgrading, and patching, and the availability of the SDDCs is provided according to the service level agreement of the subscription.

As described in U.S. patent application Ser. No. 17/464,733, filed on Sep. 2, 2021, the entire contents of which are incorporated by reference herein, the desired state of the SDDC, which specifies the configuration of the SDDC (e.g., number of clusters, hosts that each cluster would manage, and whether or not certain features, such as distributed resource scheduling, high availability, and workload control plane, are enabled), may be defined in a declarative document, and the SDDC is deployed or upgraded according to the desired state defined in the declarative document.

The declarative approach has simplified the deployment and upgrading of the SDDCs, but may still be insufficient by itself to meet the needs of customers who have multiple SDDCs deployed across different geographical regions, and deployed in a hybrid manner, e.g., on-premise, in a public cloud, or as a service. These customers want to ensure that all of their SDDCs are compliant with company policies, and are looking for an easier way to monitor their SDDCs for compliance with the company policies and manage the upgrade and remediation of such SDDCs.

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

### SUMMARY

One or more embodiments provide a cloud platform from which various services, referred to herein as “cloud services” are delivered to the SDDCs through agents of the cloud services that are running in an appliance (referred to herein as an “agent platform appliance”). The cloud platform is a computing platform that hosts containers or virtual machines corresponding to the cloud services that are delivered from the cloud platform. The agent platform appliance is deployed in the same customer environment, e.g., a private data center, as the management appliances of the SDDCs. In one embodiment, the cloud platform is provisioned in a public cloud and the agent platform appliance is provisioned as a virtual machine, and the two are connected over a public network, such as the Internet. In addition, the agent platform appliance and the management appliances are connected to each other over a private physical network, e.g., a local area network. One of the cloud services that are delivered includes an SDDC configuration service, and the SDDC configuration service has a corresponding SDDC configuration agent deployed on the agent platform appliance. All communication between the SDDC configuration service and the management software of the SDDC is carried out through the SDDC configuration agent.

A method of managing configurations of an SDDC, according to an embodiment, includes: retrieving a current configuration of a first management appliance of the SDDC and a current configuration of a second management appliance of the SDDC; calling a first custom resource object of a container orchestration platform to acquire a desired configuration of the first management appliance and calling a second custom resource object of the container orchestration platform to acquire a desired configuration of the second management appliance; determining a difference between the current configuration of the first management appliance and the desired configuration of the first management appliance and instructing the first management appliance to apply the desired configuration of the first management appliance; and determining a difference between the current configuration of the second management appliance and the desired configuration of the second management appliance and instructing the second management appliance to apply the desired configuration of the second management appliance.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a conceptual block diagram of customer environments of different organizations that are managed through a multi-tenant cloud platform.

FIG. 2 illustrates components of the cloud platform and components of an agent platform appliance that are involved in managing the configuration of the SDDC according to a desired state.

FIG. 3 illustrates a relational database table used in tracking the desired state applied to SDDCs.

FIG. 4 illustrates a condensed version of a sample desired state document.

FIG. 5 is a flow diagram of a method carried out by an SDDC configuration agent to create custom resource objects.

FIG. 6 is a diagram that depicts a sequence of steps that are carried out by the components of the cloud platform and the components of the agent platform appliance to manage the configuration of the SDDC according to the desired state.

FIG. 7 is a flow diagram of a method carried out by each controller of a container orchestration platform to bring a running state of a management appliance in compliance with the desired state.

### DETAILED DESCRIPTION

In the embodiments, the desired state of an SDDC is specified in a plurality of custom resource objects of a container orchestration platform. As used herein, an SDDC is a virtual computing environment provisioned from a plurality of host computers, storage devices, and networking devices by management software for the virtual computing environment that communicates with hypervisors running in the host computers. Also, a container orchestration platform, as used herein, is a platform that automates the operational effort required to run containerized workloads and services. The operational effort includes provisioning, deployment, scaling (up and down), networking, load balancing and the like. Kubernetes® is an example of a container orchestration platform. A custom resource definition (CRD) is a set of definitions for a customer resource object which, as used herein, is an object that allows a user of the container orchestration platform to introduce custom application programming interfaces (APIs) to the container orchestration platform.

Each of the custom resource objects is created from a desired state document and corresponds to one of a plurality of management appliances that have been deployed to manage the SDDC. In the embodiment illustrated herein, the desired state document is created in the form of a human readable and editable file, e.g., a JSON (JavaScript Object Notation) file. After the custom resource objects are created, controllers of the container orchestration platform monitor the running state of the SDDC and issue commands to the management appliances to bring the running state of the SDDC into compliance with the desired state specified in the custom resource objects.

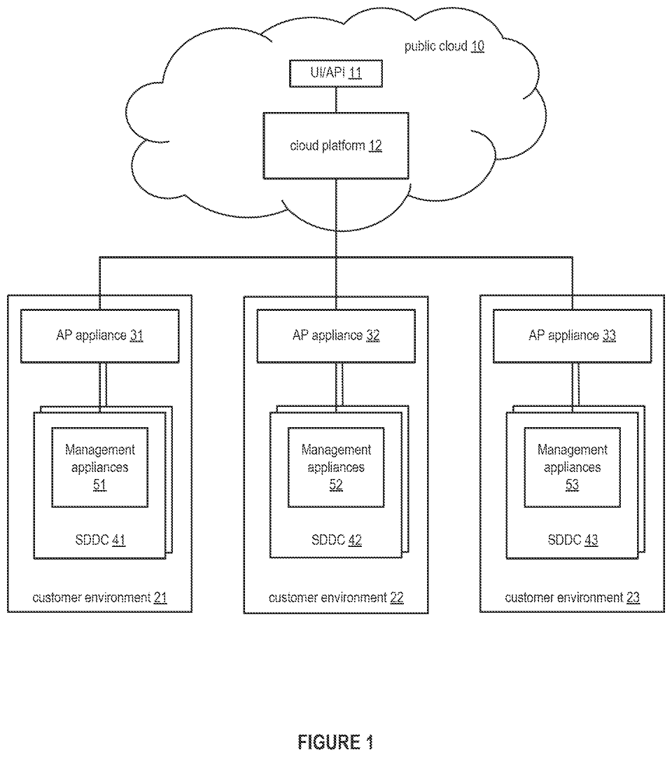

FIG. 1 is a conceptual block diagram of customer environments of different organizations (hereinafter also referred to as “customers” or “tenants”) that are managed through a multi-tenant cloud platform 12, which is implemented in a public cloud 10. A user interface (UI) or an application programming interface (API) of cloud platform 12 is depicted in FIG. 1 as UI/API 11.

A plurality of SDDCs is depicted in FIG. 1 in each of customer environment 21, customer environment 22, and customer environment 23. In each customer environment, the SDDCs are managed by respective management appliances, which include a virtual infrastructure management (VIM) server (e.g., the VMware vCenter Server® appliance) for overall management of the virtual infrastructure, and a network management server (e.g., the VMware NSX® appliance) for management of the virtual networks. For example, SDDC 41 of the first customer is managed by management appliances 51, SDDC 42 of the second customer by management appliances 52, and SDDC 43 of the third customer by management appliances 53.

The management appliances in each customer environment communicate with an agent platform (AP) appliance, which hosts agents that communicate with cloud platform 12 to deliver cloud services to the corresponding customer environment. The communication is over a local area network of the customer environment where the AP appliance is deployed. For example, management appliances 51 in customer environment 21 communicate with AP appliance 31 over a local area network of customer environment 21. Similarly, management appliances 52 in customer environment 22 communicate with AP appliance 32 over a local area network of customer environment 22, and management appliances 53 in customer environment 23 communicate with AP appliance 33 over a local area network of customer environment 23.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions.

In the embodiments, each of the agent platform appliances and the management appliances is a VM instantiated on one or more physical host computers having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, any of the agent platform appliances and the management appliances may be implemented as a physical host computer having the conventional hardware platform described above.

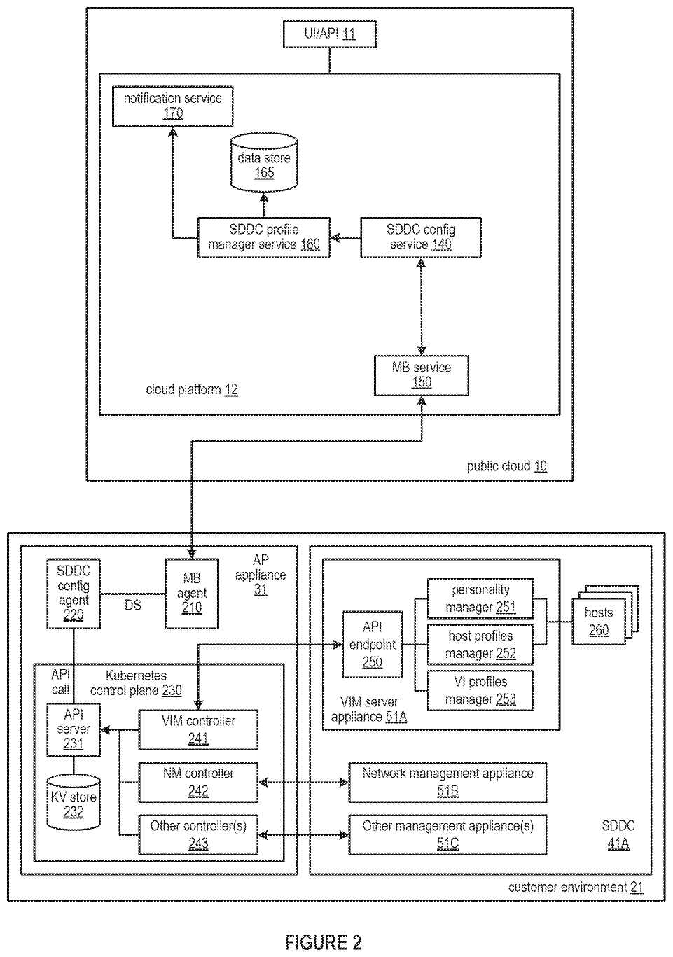

FIG. 2 illustrates components of cloud platform 12 and AP appliance 31 that are involved in managing the configuration of the SDDC according to a desired state. Cloud platform 12 is accessible by different customers through UI/API 11 and each of the different customers manage the configuration of its group of SDDCs through cloud platform 12 according to a desired state of the SDDCs that the customer defines in a desired state document. In FIG. 2, the management of the configuration of SDDCs in customer environment 21, in particular that of SDDC 41A, is selected for illustration. It should be understood that the description given herein for customer environment 21 also apply to other customer environments, including customer environment 22 and customer environment 23.

Cloud platform 12 includes a group of services running in virtual infrastructure of public cloud 10 through which a customer can manage the desired state of its group of SDDCs by issuing commands through UI/API 11. SDDC configuration service 140 is responsible for accepting configuration commands made through UI/API 11 and dispatching configuration tasks to a particular customer environment through message broker (MB) service 150. MB service 150 is responsible for exchanging messages with message broker (MB) agents deployed in different customer environments upon receiving a request to exchange messages from the MB agents. The communication between MB service 150 and the different MB agents is, for example, over a public network such as the Internet. SDDC profile manager service 160 is responsible for storing desired state documents in data store 165 (e.g., a virtual disk or a depot accessible using a URL) and, for each of the SDDCs, tracks the history of the desired state document associated therewith, e.g., using a relational database (hereinafter referred to as “desired state tracking database”).

In one embodiment, each of the cloud services is a microservice that is implemented as one or more container images executed on a virtual infrastructure of public cloud 10. Similarly, each of the agents and services deployed on the AP appliances is a microservice that is implemented as one or more container images executing in the AP appliances.

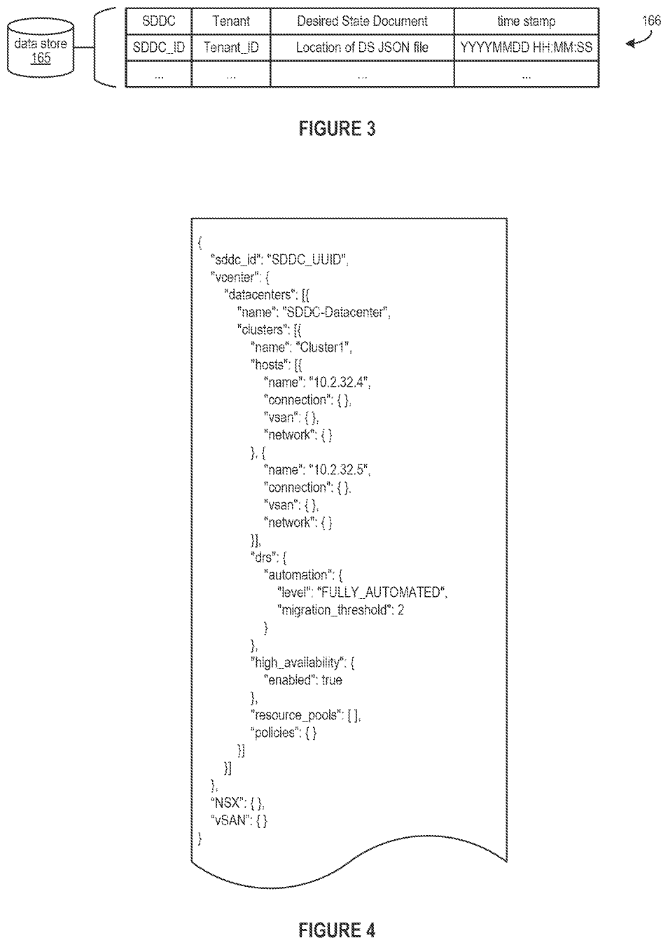

FIG. 3 illustrates a relational database table 166 of the desired state tracking database that is used to track the history. Each time a desired state is applied to an SDDC, an entry is added to table 166. The entry added to table 166 identifies the SDDC using its ID (SDDC_ID), the tenant for whom the SDDC is deployed (Tenant_ID), the location where the desired state document (DS JSON file) is stored, and a time stamp indicating the date (YYYYMMDD) and time (HH:MM:SS) the desired state is applied to the SDDC. When SDDC configuration service 140 dispatches a configuration task to apply the desired state to an SDDC, SDDC configuration service 140 calls SDDC profile manager service 160 to store the desired state document in data store 165 and to update the desired state tracking database to record what (e.g., which desired state document) is being applied to where (e.g., to which SDDC) and when (e.g., date and time). Thereafter, SDDC profile manager service 160 posts notifications about any changes made to the desired state tracking database to notification service 170, and an administrator for the tenant can get such notifications through UI/API 11.

AP appliance 31 in customer environment 21 has various agents of cloud services running in cloud platform 12 deployed thereon. The two agents depicted in FIG. 2 are MB agent 210 and SDDC configuration agent 220. MB agent 210 periodically polls MB service 150 to exchange messages with MB service 150, i.e., to receive messages from MB service 150 and to transmit to MB service 150 messages that it received from other agents deployed in AP appliance 31. If a message received from MB service 150 includes a configuration task to apply the desired state, MB agent 210 routes the message to SDDC configuration agent 220.

In one embodiment, the message that includes the configuration task to apply the desired state also includes a desired state document that contains the desired states of different management appliances of customer environment 21. FIG. 4 illustrates a condensed version of a sample desired state document, and includes entries for three management appliances of an SDDC identified as “SDDC_UUID.” The three management appliances are identified as “vcenter,” which corresponds to VIM server appliance 51A depicted in FIG. 2, “NSX,” which corresponds to a network management appliance 51B depicted in FIG. 2, and “vSAN,” which corresponds to one of other managements appliances 51C depicted in FIG. 2.

VIM server appliance 51A has various services running therein for managing the configuration thereof and the configuration of the SDDC managed thereby. These services include: (1) an API endpoint 250 for configuration API calls made to VIM server appliance 51A; (2) a personality manager 251, which is responsible for applying the desired image of the virtualization software to a cluster of hosts 240 according to the desired state; (3) host profiles manager 252, which is responsible for applying the desired configurations of a cluster of hosts 260 according to the desired state; and (4) virtual infrastructure (VI) profiles manager 253, which is responsible for applying the desired configuration of the virtual infrastructure managed by VIM server appliance 51A (e.g., the number of clusters, the hosts that each cluster would manage, etc.) and the desired configuration of various features provided by software services running in VIM server appliance 51A (e.g., distributed resource scheduling (DRS), high availability (HA), and workload control plane), according to the desired state. Network management appliance 51B and other managements appliances 51C also have similar services running therein for managing the configuration thereof and the configuration of the SDDC managed thereby.

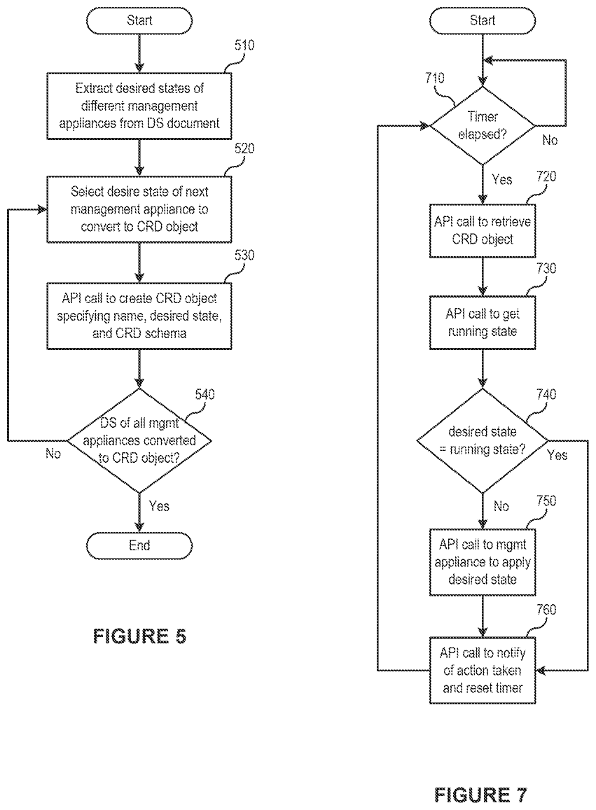

Upon receiving the message that includes configuration task to apply the desired state, SDDC configuration agent 220 executes the steps of a method that are depicted in FIG. 5 to convert the desired states for each of the management appliances defined in the desired state document into custom resource objects of a container orchestration platform. In the embodiments illustrated herein, Kubernetes is employed as the container orchestration platform and the desired states for each of the management appliances are converted into custom resource definition (CRD) objects. The control plane of Kubernetes is depicted in FIG. 2 as Kubernetes control plane 230 which includes an API server 231 and key-value (KV) store 232, and a plurality of controllers 241, 242, 243 for each of the management appliances.

At step 510, SDDC configuration agent 220 extracts desired states for each of the different management appliances from the desired state document. Then, at step 520, SDDC configuration agent 220 selects the desired state of one of the management appliances for converting into a CRD object. At step 530, SDDC configuration agent 220 makes an API call to API server 231 to create the CRD object corresponding to the selected desired state. In the API call, SDDC configuration agent 220 specifies the name of the CRD object, the desired state (which specifies desired values for different configurable properties of one of the management appliances), and a CRD schema against which the desired state is validated. For example, the CRD schema defines constraints (range, minimum/maximum, etc.) for each of the different configurable properties, and values that do not meet the constraints fail the validation and trigger an error message. At step 540, SDDC configuration agent 220 determines if the desired states of all management appliances have been converted to CRD objects. If so, the method ends. If not, the method returns to step 520.

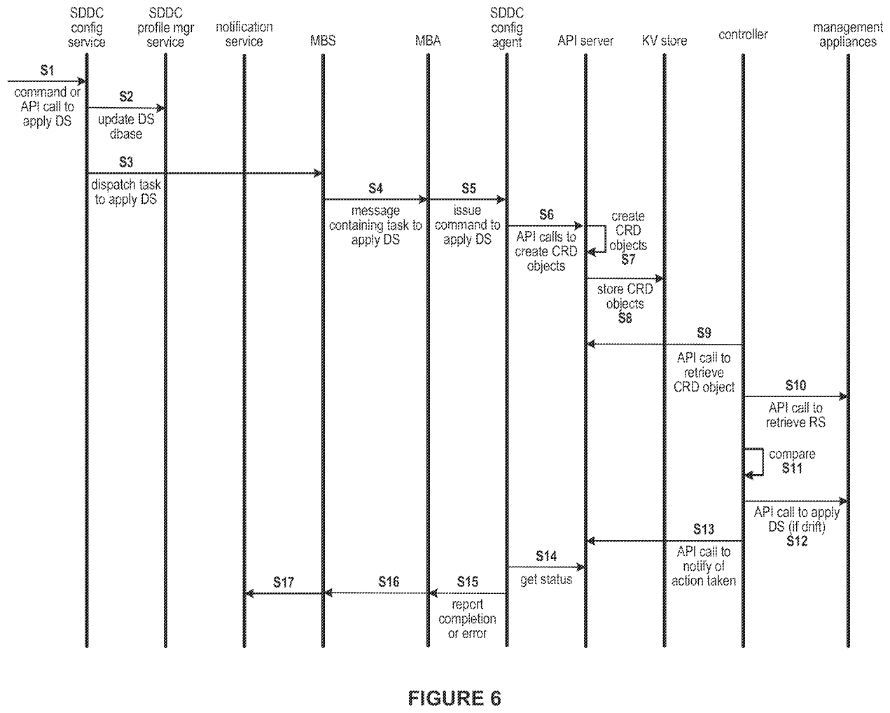

FIG. 6 is a diagram that depicts a sequence of steps that are carried out by the components of cloud platform 12 and the components of AP appliance 31 to manage the configuration of SDDC 41A according to the desired state. In the example given herein, the steps carried out by one AP appliance, namely AP appliance 31, are depicted for simplicity. It should be understood that steps similar to the ones carried out by one AP appliance 31 are also carried out by the AP appliances of other customer environments when managing the configuration of SDDCs deployed in the other customer environments. The sequence of steps depicted in FIG. 6 is carried out after AP appliance 31 has been deployed and registered in customer environment 21 to host agents of cloud services running in cloud platform 12, including all of the agents shown in FIG. 2.

In the embodiment illustrated herein, the steps depicted in FIG. 6 are triggered at step S1 when a command or an API call is received by SDDC configuration service 140 to apply the desired state, which is defined in a desired state document (e.g., a JSON file) identified in the API call. In another embodiment, the steps depicted in FIG. 6 are triggered when the desired state is changed by the administrator. Then, SDDC configuration service 140 at step S2 calls an API of SDDC profile manager service 160 to update the desired state tracking database as described above, and at step S3 dispatches the configuration task to apply the desired state by creating a message that contains the configuration task and the desired state document and transmitting the message to MB service 150.

At step S4, MB service 150 transmits the message to MB agent 210 of AP appliance 31 upon receiving a request to exchange messages from MB agent 210. MB agent 210 is responsible for routing messages from MB service 150 to the other agents deployed on AP appliance 31 and at step S5 routes the message containing the configuration task and the desired state document to SDDC configuration agent 220 of AP appliance 31. Then, SDDC configuration agent 220 carries out the steps of FIG. 5 to make API calls to API server 231 to create CRD objects from the desired states defined in the desired state document. In response to the API calls, API server 231 carries out step S7 to create the CRD objects and S8 to store the created CRD objects in KV store 232.

In general, controllers of Kubernetes control plane 230 are responsible for checking (at a user-configurable frequency) that the current state of objects they are managing match their desired states. If not, the controllers execute a reconciliation loop to bring the current state into compliance with the desired state. Controller 241 operates in this manner to bring the current state of VIM server appliance 51A into compliance with the desired state of VIM server appliance 51A. Similarly, controllers 242, 243 operate in this manner to bring the current state of network management appliance 51B and other management appliance 51C into compliance with their desired states.

The triggering and the execution of the reconciliation loop of each of controllers 241, 242, 243 are depicted in FIG. 7. Steps 720, 730, 740, 750, and 760 correspond respectively to steps S9, S10, S11, S12, and S13 in FIG. 6. The reconciliation loop is trigger at step 710 when a timer set to a certain user-configurable value elapses. When the timer elapses, the controller at step 720 makes an API call to API server 231 to retrieve the CRD object corresponding to the management appliance it is managing. Then, the controller at step 730 makes an API call to the management appliance it is managing to retrieve the running state thereof. At step 740, the controller compares the desired state, which is specified by the retrieved CRD object, and the running state. If the two states do not match (step 740; No), the controller at step 750 makes an API call to the management appliance it is managing to apply the desired state, and at step 760 makes an API call to API server 231 to notify API server 231 of the action taken and resets the timer to the user-configurable value. If the two states match (step 740; Yes), the controller skips step 750 and carries out step 760 after step 740. After step 760, the method returns to step 710 to wait for the timer to elapse.

Returning to FIG. 6, after issuing the API calls to create the CRD objects at step S6, SDDC configuration agent 220 periodically issues API calls to API server 231 get the status reported by the controllers, i.e., whether the running states of all the management appliances match their desired states or there is an error. The API call at step S14 represents the “get status” API call made after the controllers reported that the running states of all the management appliances match their desired states or reported an error. Then, SDDC configuration agent 220 prepares a message that indicates completion of the configuration task it received at step S5 or the error. The message is transmitted from SDDC configuration agent 220 to MB agent 210 at step S15, and from MB agent 210 to MB service 150 at step S16. At step S17, the message is routed by MB service 150 to notification service 170, which notifies the administrator of the completion or the error through UI/API 11.

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing configurations of a software-defined data center (SDDC), comprising:
(a) retrieving a current configuration of a first management appliance of the SDDC and a current configuration of a second management appliance of the SDDC;
(b) calling a first custom resource object of a container orchestration platform to acquire a desired configuration of the first management appliance and calling a second custom resource object of the container orchestration platform to acquire a desired configuration of the second management appliance;
(c) determining a difference between the current configuration of the first management appliance and the desired configuration of the first management appliance and instructing the first management appliance to apply the desired configuration of the first management appliance; and
(d) determining a difference between the current configuration of the second management appliance and the desired configuration of the second management appliance and instructing the second management appliance to apply the desired configuration of the second management appliance.

2. The method of claim 1, wherein the first and second custom resource objects are each created from a desired state document that specifies the desired state of the SDDC.

3. The method of claim 2, wherein the desired state document is retrieved from a cloud platform and the container orchestration platform is deployed on an agent platform appliance that communicates with the first and second management appliances over a local area network and with the cloud platform over a public network.

4. The method of claim 3, wherein the container orchestration platform is Kubernetes, and Kubernetes controllers perform steps (a), (b), (c), and (d).

5. The method of claim 2, wherein a first API call is made to an application programming interface (API) server of the container orchestration platform to create the first custom resource object and a second API call is made to the API server to create the second custom resource object.

6. The method of claim 5, wherein the first API call specifies a first schema against which the desired configuration of the first management appliance specified in the desired state document is validated, and the second API call specifies a second schema against which the desired configuration of the second management appliance specified in the desired state document is validated.

7. The method of claim 1, wherein the first management appliance has deployed thereon virtual infrastructure management software and the second management appliance has deployed thereon network virtualization management software.

8. A non-transitory computer readable medium comprising instructions to be executed in a computer system to carry out a method of managing configurations of a software-defined data center (SDDC), said method comprising:
(a) retrieving a current configuration of a first management appliance of the SDDC and a current configuration of a second management appliance of the SDDC;
(b) calling a first custom resource object of a container orchestration platform to acquire a desired configuration of the first management appliance and calling a second custom resource object of the container orchestration platform to acquire a desired configuration of the second management appliance;
(c) determining a difference between the current configuration of the first management appliance and the desired configuration of the first management appliance and instructing the first management appliance to apply the desired configuration of the first management appliance; and
(d) determining a difference between the current configuration of the second management appliance and the desired configuration of the second management appliance and instructing the second management appliance to apply the desired configuration of the second management appliance.

9. The non-transitory computer readable medium of claim 8, wherein the first and second custom resource objects are each created from a desired state document that specifies the desired state of the SDDC.

10. The non-transitory computer readable medium of claim 9, wherein the desired state document is retrieved from a cloud platform and the container orchestration platform is deployed on an agent platform appliance that communicates with the first and second management appliances over a local area network and with the cloud platform over a public network.

11. The non-transitory computer readable medium of claim 10, wherein the container orchestration platform is Kubernetes, and Kubernetes controllers perform steps (a), (b), (c), and (d).

12. The non-transitory computer readable medium of claim 9, wherein a first API call is made to an application programming interface (API) server of the container orchestration platform to create the first custom resource object and a second API call is made to the API server to create the second custom resource object.

13. The non-transitory computer readable medium of claim 12, wherein the first API call specifies a first schema against which the desired configuration of the first management appliance specified in the desired state document is validated, and the second API call specifies a second schema against which the desired configuration of the second management appliance specified in the desired state document is validated.

14. A computer system running in a customer environment and communicating with a cloud platform to manage configurations of a software-defined data center (SDDC), wherein the computer system is programmed to carry out the steps of:
(a) retrieving a current configuration of a first management appliance of the SDDC and a current configuration of a second management appliance of the SDDC;
(b) calling a first custom resource object of a container orchestration platform to acquire a desired configuration of the first management appliance and calling a second custom resource object of the container orchestration platform to acquire a desired configuration of the second management appliance;
(c) determining a difference between the current configuration of the first management appliance and the desired configuration of the first management appliance and instructing the first management appliance to apply the desired configuration of the first management appliance; and
(d) determining a difference between the current configuration of the second management appliance and the desired configuration of the second management appliance and instructing the second management appliance to apply the desired configuration of the second management appliance.

15. The computer system of claim 14, wherein the first and second custom resource objects are each created from a desired state document that specifies the desired state of the SDDC.

16. The computer system of claim 15, wherein the desired state document is retrieved from a cloud platform and the container orchestration platform is deployed on an agent platform appliance that communicates with the first and second management appliances over a local area network and with the cloud platform over a public network.

17. The computer system of claim 16, wherein the container orchestration platform is Kubernetes, and Kubernetes controllers perform steps (a), (b), (c), and (d).

18. The computer system of claim 15, wherein a first API call is made to an application programming interface (API) server of the container orchestration platform to create the first custom resource object and a second API call is made to the API server to create the second custom resource object.

19. The computer system of claim 18, wherein the first API call specifies a first schema against which the desired configuration of the first management appliance specified in the desired state document is validated, and the second API call specifies a second schema against which the desired configuration of the second management appliance specified in the desired state document is validated.

20. The computer system of claim 14, wherein the first management appliance has deployed thereon virtual infrastructure management software and the second management appliance has deployed thereon network virtualization management software.
